(19) United States
(12) Patent Application Publication
(10) Pub. No.: US 2025/0222653 A1
(43) Pub. Date: Jul. 10, 2025

(54) HEAD, DEPOSITION ARRANGEMENT, AND METHODS FOR CONTROLLING A HEAD

(71) Applicant: Sindri Production AB, Linköping (SE)

(72) Inventors: Patrik Härnman, Linköping (SE); Taisto Kalevi Nyström, Nyköping (SE); Håkan Löfholm, Huddinge (SE)

(21) Appl. No.: 19/090,030

(22) Filed: Mar. 25, 2025

Related U.S. Application Data
(62) Division of application No. 17/257,904, filed on Jan. 5, 2021.

(30) Foreign Application Priority Data
Jul. 9, 2018 (SE) 1850868-9

(51) Int. Cl. B29C 64/209; B22F 10/28; B22F 10/85; B22F 12/50; B22F 12/55; B29C 64/153; B29C 64/321; B29C 64/336; B29C 64/393; B33Y 10/00; B33Y 30/00

(52) U.S. Cl. CPC B29C 64/209; B22F 10/28; B22F 10/85; B22F 12/50; B22F 12/55; B29C 64/153; B29C 64/321; B29C 64/336; B29C 64/393; B33Y 10/00; B33Y 30/00

(57) ABSTRACT

The present invention relates to a head (100) of a deposition arrangement (600) used to fabricate three-dimensional objects, The head (100) includes a casing (110) with a first end (112) including an end opening (114) arranged to be positioned on a surface (210a, 210b, . . . , 210n). The head (100) further includes a material receiving arrangement (115) arranged to receive a granular material (125) into the casing (110) and onto the surface (210a, 210b, . . . , 210n). A piston (130) is arranged to move inside the casing (110) towards the first end (112) such that the piston (130) presses the granular material (125) against the surface (210a, 210b, . . . , 210n) and the granular material (125) thereby forms a deposition volume V. The invention further relates to the deposition arrangement (600) including the head (100) and corresponding methods.

### TECHNICAL FIELD

The present invention relates to a head of a deposition arrangement, a deposition arrangement including such a head and corresponding methods.

### BACKGROUND

Additive Manufacturing (AM) is a manufacturing process for building three-dimensional objects by joining or solidifying material under computer control. The material may initially be e.g. a granular material, such as a powder. The object may be built by successively adding layer after layer of the material. This is the case in e.g. powder bed AM systems, where complex objects can be fabricated through the layer-by-layer consolidation of powder on a powder bed. The consolidation may be achieved with the input of energy, which causes the particles to connect through sintering or by melting together. Typical sources of energy include lasers, electron beams, or high frequency magnetic fields.

In conventional powder bed AM, layers of powder are sequentially spread over the powder bed. Thus, an earlier layer holds a subsequent layer that is spread over the powder bed. During consolidation, grains of the topmost layer of loose powder are fused to both an earlier layer and neighboring loose grains. The consolidation is achieved by using spatially compact energy sources such as e.g. laser to locally consolidate the particles in a specific pattern to form a three-dimensional object.

### SUMMARY

Conventional powder bed AM is usually restricted to one material and can therefore not fabricate objects comprising two or more materials. This is a disadvantage as the use of two or more materials can provide objects with specific and varying properties related to for example thermal conductivity, electrical conductivity, and mechanical properties.

An additional disadvantage with conventional powder bed AM is that the powder surrounding the object to be fabricated usually is destroyed, i.e. cannot be reused. This is e.g. the case when aluminum is used, resulting in increased fabrication Costs for objects fabricated from aluminum using conventional power bed AM.

Consequently, there is a need to improve power bed AM to efficiently produce three-dimensional objects.

An objective of embodiments of the present invention is to provide a solution which mitigates or solves the herein mentioned drawbacks and problems.

The above and further objectives are achieved by the subject matter of the independent claim. Further advantageous implementation forms of the present invention are defined by the dependent claims and other embodiments.

According to a first aspect of the invention, the above mentioned and other objectives are achieved with a head of a deposition arrangement arranged to create layers of deposition volumes, the head including:
a casing including at least three wall segments defining a deposition area and extending from a first end to a second end of the casing, the first end of the casing including an end opening arranged to be positioned on a surface; and
at least one material receiving arrangement arranged to receive a granular material into the casing and onto the surface;
characterized by:
a piston arranged to be movable inside of the casing, towards the first end and towards the second end, such that the piston presses the granular material against the surface when the piston is moved towards the first end, the granular material thereby forming a deposition volume.

An advantage with a head of a deposition arrangement according to the first aspect is that the head can deposit/form the granular material on the surface in a well-defined deposition volume. By creating layers of such well-defined deposition volumes, complex objects can be fabricated with high accuracy.

According to an embodiment of the invention at least one of the at least three wall segments is individually retractable from the surface.

An advantage with this embodiment is that the head can deposit deposition volumes next to each other, i.e. in contact with each other, such that no gaps are created between the deposition volumes. Thereby, continuous layers of deposition volumes can be fabricated.

According to an embodiment of the invention the at least one retractable wall segment is arranged to be retracted by use of at least one in the group of:
mechanically controlled retraction; and
temperature controlled retraction.

An advantage with this embodiment is that well known technical means can be used to achieve a well-defined and exact retraction of the at least one retractable wall segment.

According to an embodiment of the invention the at least one retractable wall segment is arranged to be retracted a distance essentially corresponding to a height of at least one adjacent deposition volume formed on the surface.

An advantage with this embodiment is that while the other wall segments of the head are placed on the surface, the at least one retractable wall segment can be placed on top of the at least one adjacent deposition volume. Thereby, a deposition volume can be formed next to the at least one adjacent deposition volume without any gap in between.

According to an embodiment of the invention the piston is further arranged to cause a vibration to spread the provided granular material over the deposition area.

An advantage with this embodiment is that the granular material can be more evenly spread over the deposition area before the piston presses the granular material against the surface.

According to an embodiment of the invention the material receiving arrangement includes at least one wall opening in at least one of the wall segments.

An advantage with this embodiment is that the material receiving arrangement can be implemented in a simple and robust way.

According to an embodiment of the invention the casing has one in the group of:
three wall segments forming a triangular deposition area;
four wall segments forming a rectangular deposition area;
four wall segments forming a square deposition area;
six wall segments forming a hexagonal deposition area; and
eight wall segments forming an octagonal deposition area.

An advantage with this embodiment is that the shape of the deposition area is suitable for fitting multiple deposition areas next to each other to form larger continuous areas without any gaps.

According to a second aspect of the invention, the above mentioned and other objectives are achieved with a deposition arrangement, characterized by:
at least one head according to any one of the embodiments according to the first aspect;
at least one material providing arrangement arranged to provide granular material to the at least one material receiving arrangement;
at least one bed including a surface;
at least one positioning arrangement arranged to position the head on the surface of the bed or on a surface of a previously deposited layer of depositions volumes;
at least one material conversion arrangement arranged to convert the granular material of the deposition volume V into a solid material; and
at least one control unit arranged to control one or more of the at least one head, the at least one material providing arrangement, the at least one bed, the at least one positioning arrangement, and the at least one material conversion arrangement.

An advantage with this embodiment is that the deposition arrangement can deposit a granular material in well-defined deposition volumes, resulting in that very exact geometrical shapes can be formed. The deposition arrangement can thereby fabricate complex objects with high accuracy.

According to an embodiment of the invention the at least one positioning arrangement is arranged to move the head in a first direction, in a second direction perpendicular to the first direction, and in a third direction perpendicular to the first direction and the second direction.

An advantage with this embodiment is that the head can be moved with a high degree of freedom, allowing deposition volumes to be deposited anywhere on the surface.

According to an embodiment of the invention each one of the at least one material conversion arrangement is arranged to utilize one in the group of:
melting; and
sintering.

An advantage with this embodiment is that well known techniques can be used to convert the material into a solid material, which reduces the implementation costs.

According to an embodiment of the invention each one of the at least one material conversion arrangement is arranged to perform one in the group of:
converting the granular material into a solid material individually for each layer of deposition volumes; and
converting the granular material into a solid material simultaneously for two or more layers of deposition volumes.

An advantage with this embodiment is that the conversion of the material may be performed in a flexible way, and may be adapted to the objects to be produced and/or to the materials used.

According to an embodiment of the invention the at least one material providing arrangement includes:
at least one container including the granular material; and
at least one tube arranged to be attached to the at least one container, respectively, the at least one tube being arranged to provide the granular material from the at least one container to the at least one material receiving arrangement.

An advantage with this embodiment is that the granular material may be provided into the casing using a reliable material providing arrangement with low complexity.

According to an embodiment of the invention the at least one tube is arranged to be movable relative to the at least one material receiving arrangement, respectively, such that the granular material is spread over the deposition area.

An advantage with this embodiment is that the spreading of the granular material over the deposition area during the providing of the granular material can be improved, resulting in a more even spread of the granular material, which makes it possible to form/create a deposition volume with a more even density and/or makes it possible for the piston to more efficiently and accurately press the material against the surface.

According to an embodiment of the invention the at least one material providing arrangement is further arranged to cause a vibration to spread the provided granular material over the deposition area.

An advantage with this embodiment is that the spreading of the granular material over the deposition area during the providing of the granular material can be improved, resulting in a more even spread of the granular material, which makes it possible to form/create a deposition volume with a more even density.

According to a third aspect of the invention, the above mentioned and other objectives are achieved with a method for controlling at least one head of a deposition arrangement according to any one of the embodiments according to the first aspect, the method includes:
moving the head to a predetermined position on the surface;
positioning the end opening of the casing on the surface;
providing a predetermined amount of the granular material into the casing;
pressing the piston towards the surface, such that the granular material is pressed against the surface and forms a deposition volume;
retracting the casing from the surface; and
retracting the piston from the surface,

An advantage with this embodiment is that the head can be controlled to deposit the granular material on the surface in a well-defined deposition volume.

According to an embodiment of the invention the method further includes:
performing the method a first time, wherein a first granular material is provided into the casing during the providing; and
performing the method a second time, wherein a second granular material different from the first granular material is provided into the casing during the providing.

An advantage with this embodiment is that one head can be controlled to deposit deposition volumes of two different materials. In this way, more or less complex objects including two or more different materials can be fabricated with one head.

According to an embodiment of the invention the method further includes:
performing the method using a first head, wherein the providing includes providing a predetermined amount of a first granular material into a casing of the first head; and
performing the method using a second head, wherein the providing includes providing a predetermined amount of a second granular material different from the first granular material into a casing of the second head.

An advantage with this embodiment is that two heads can be controlled, where each head deposit deposition volumes of a specific materials. In this way, objects including two or more different materials can be fabricated with two heads.

According to further embodiments of the present invention, more than two granular materials may be deposited using more than two heads. The herein described use of a first and second head and a first and second granular material is thus only one example of what may be achieved by the present invention. The scope of the present invention covers essentially any number of used granular materials and/or heads.

According to an embodiment of the invention a pressure used for the pressing of the piston towards the surface is regulated based on a stability of the surface.

An advantage with this embodiment is that the pressure can be adapted such that deposition volumes can be safely deposited on a surface of a layer which is not yet solidified.

According to an embodiment of the invention the surface includes a gap between at least two adjacent deposition volumes having a surface area, the surface area being smaller than the deposition area; and
the positioning includes positioning the casing such that the end opening covers the gap, and
after the providing and before the pressing the casing is moved parallel with the surface such that the granular material is moved into the gap.

An advantage with this embodiment is that a partial deposition volume smaller than the deposition volume of the head can be formed, allowing e.g. gaps in a surface to be filled and/or building even more complex and/or detailed objects.

According to a fourth aspect of the invention, the above mentioned and other objectives are achieved with a computer program comprising instructions which, when the program is executed by a computer, cause the computer to carry out the method according to any of the embodiment according to the third aspect.

According to a fifth aspect of the invention, the above mentioned and other objectives are achieved with a computer-readable medium comprising instructions which, when executed by a computer, cause the computer to carry out the method according to any of the embodiment according to the third aspect.

According to a sixth aspect of the invention, the above mentioned and other objectives are achieved with a control unit of a deposition arrangement arranged to control the deposition arrangement to carry out the method according to any of the embodiment according to the third aspect.

According to a seventh aspect of the invention, the above mentioned and other objectives are achieved with use of a deposition arrangement according to any of the embodiment according to the second aspect for creating an object including a first element comprising a first material and at least one second element comprising at least one second material, respectively, wherein the first element and the at least one second element are fixed to each other by at least one mechanical coupling.

An advantage with this embodiment is that the deposition arrangement can be used to fabricate objects including a mechanical coupling between elements of different materials.

According to an embodiment of the invention the first and the at least one second material are unbondable to each other.

An advantage with this embodiment is that the deposition arrangement can be used to fabricate objects including a mechanical coupling between elements of different materials, where the different materials cannot be coupled using e.g. welding.

Further applications and advantages of the present invention will be apparent from the following detailed description.

### BRIEF DESCRIPTION OF THE DRAWINGS

The appended drawings are intended to clarify and explain different embodiments of the present invention, in which;

FIGS. 1a-b show a deposition arrangement according to an embodiment of the invention;

FIGS. 2a-b show a head of a deposition arrangement according to an embodiment of the invention;

FIGS. 3a-d show deposition areas of a casing according to various embodiments of the invention;

FIG. 4 shows a head including a retractable wall segment according to various embodiments of the invention;

FIGS. 5a-f show different stages of a method according to an embodiment of the invention;

FIGS. 6a-b show a deposition arrangement including a first head and a second head according to an embodiment of the invention;

FIGS. 7a-c show objects including a joint according to various embodiments of the invention;

FIG. 8 shows forming of layers according to an embodiment of the invention.

### DETAILED DESCRIPTION

The invention is related to a deposition arrangement which can fabricate a three-dimensional object from one or more materials. The deposition arrangement may e.g. be, or be part of, an additive manufacturing arrangement but is not limited thereto. The deposition arrangement includes a head according to various embodiments of the invention, the head is arranged to deposit a granular material in depositions volumes on a bed of the deposition arrangement such that layers of deposition volumes are created. The granular material may e.g. be a powder, sand or any other granular material comprising grains. As a non-limiting example, the material may have a grain diameter in the interval of 15-100 micrometer.

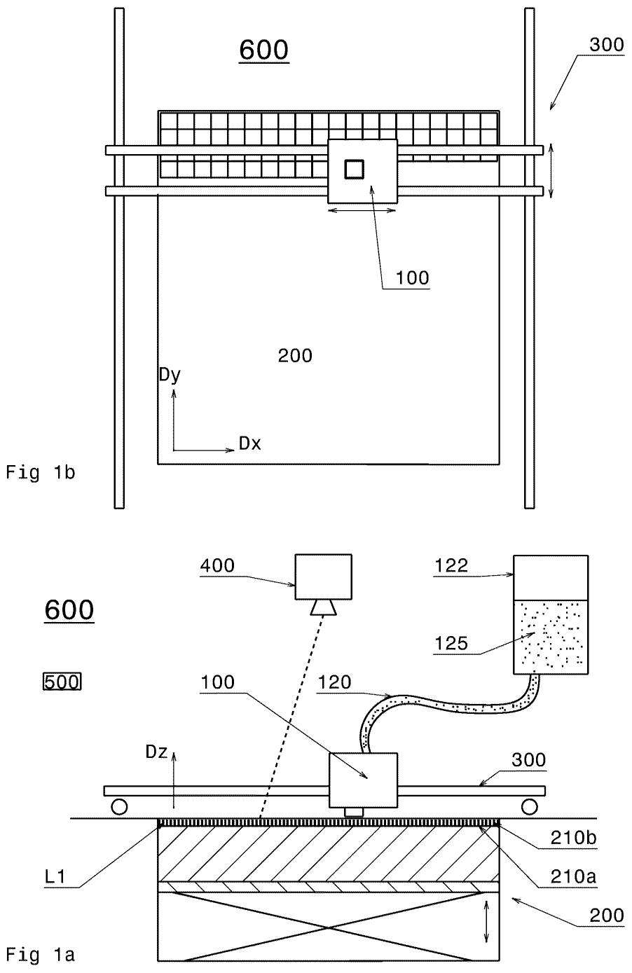

FIGS. 1a-b schematically shows a deposition arrangement 600 according to an embodiment of the invention. In the embodiment shown in FIGS. 1a-b, the deposition arrangement 600 includes a head 100 arranged on a positioning arrangement 300 and a bed 200 including a surface 210a, 210b, . . . , 210n upon which the head 100 deposits a granular material 125 in a deposition volume V. The deposition arrangement 600 also includes at least one material providing arrangement 120, which is arranged to provide granular material to the head 100, more specifically to at least one material receiving arrangement 115 of the head. The at least one material providing arrangement 120 is described more in detail below, As described above, the granular material 125 may e.g. be a powder and may be provided to the head 100 from a container 122. The positioning arrangement 300 is arranged to position the head 100 on the surface 210a, 210b, . . . 210n of the bed 200. The surface 210a, 210b, . . . , 210n may correspond to the surface 210a of the actual bed 200 or to the surface 210b, . . . , 210n of a previously deposited layer L₁, L₂, . . . , Lₙ of deposition volumes V. In other words, the surface 210n may in this disclosure correspond to the upper surface of the layer Lₙ₋₁ of deposition volumes V facing the head 100.

The deposition arrangement 600 further includes a material conversion arrangement 400, shown in FIG. 1a. The material conversion arrangement 400 is arranged to convert the granular material 125 of the deposition volume V into a solid material. In various embodiments, the material conversion arrangement 400 is arranged to utilize melting or sintering to solidify the granular material 125 of the deposition volume V. Both melting and sintering are based on the input of energy, and any known source of energy, such as e.g. lasers, electron beams, or high frequency magnetic fields, may be used to achieve the melting or sintering, as is known by a skilled person. Furthermore, the melting and/or sintering may be performed each time a new layer L₁, L₂, . . . , Lₙ of deposition volumes V has been deposited, or may be performed for more than one layer L₁, L₂, . . . , Lₙ of deposition volumes V at a time. Thus, the material conversion arrangement 400 may be arranged to perform conversion of the granular material 125 into a solid material individually for each layer L₁, L₂, . . . , Lₙ of deposition volumes V. The material conversion arrangement 400 may further be arranged to perform conversion of the granular material 125 into a solid material simultaneously for two or more layers L₁, L₂, . . . , Lₙ of deposition volumes V. The material conversion arrangement 400 may further be arranged to perform conversion of the granular material 125 into a solid material for portions of one or more layers L₁, L₂, . . . , Lₙ of deposition volumes V. For example, when the head 100 has deposited one portion of a first layer L₁ of deposition volumes V, the material conversion arrangement 400 may start the conversion of that portion of the first layer L₁ while the head 100 continues to deposit another portion of the first layer L₁.

In the embodiment shown in FIG. 1a, the material conversion arrangement 400 is arranged to perform conversion of the granular material 125 into a solid material while the one or more layers L₁, L₂, . . . , Lₙ of deposition volumes V are remaining on the bed 200 of the deposition arrangement 600. However, in some embodiments, the one or more layers L₁, L₂, . . . , Lₙ of deposition volumes V may be moved from the bed 200 of the deposition arrangement 600 before being converted into a solid material by the material conversion arrangement 400. Hence, the material conversion arrangement 400 may be arranged external to, i.e. separate from, the bed 200 of the deposition arrangement 600, e.g. at a distance from the bed 200 of the deposition arrangement 600. In such embodiments, the material conversion arrangement 400 may e.g. be a heated chamber, such as a furnace, to which the one or more layers L₁, L₂, . . . , Lₙ of deposition volumes V are moved to be converted into a solid material by energy in the form of heat.

To control the deposition and conversion of the granular material 125, the deposition arrangement 600 includes at least one control unit 500, as shown in FIG. 1a. The at least one control unit 500 is arranged to control one or more of the head 100, the material providing arrangement 120, the bed 200, the positioning arrangement 300, and the material conversion arrangement 400. For example, the different parts of the deposition arrangement 600 may all be controlled by one control unit 500, or the different parts of the deposition arrangement 600 may be controlled by separate control units 500 which may communicate with each other. The control unit 500 may be connected to the parts of the deposition arrangement 600 which it controls through wired or wireless communication means (not shown in FIG. 1a). The control unit 500 may be arranged to control the deposition arrangement 600 to carry out any method for depositing deposition volumes V according to embodiments of the invention.

The positioning arrangement 300 may be arranged to move the head 100 of the deposition arrangement 600 in a first direction Dₓ and in a second direction D_{y} perpendicular to the first direction Dₓ, as shown in FIG. 1b. In this way, the head 100 of the deposition arrangement 600 can be positioned anywhere on the surface 210a, 210b, . . . , 210n of the bed 200. In each position, the head 100 may deposit a deposition volume V of the granular material 125. In the embodiment shown in FIG. 1b, the positioning arrangement 300 moves the head 100 sequentially in the first direction Dₓ from one end of the bed 200 to an opposite end of the bed 200, thereby creating a row of deposition volumes V of the granular material 125. The positioning arrangement 300 further moves the head 100 in the second direction D_{y} to start a new row of deposition volumes V next to the previous row of deposition volumes V. In this way, the bed 200 may step by step be covered by a layer Lₙ of deposition volumes V. However, the positioning arrangement 300 may according to various embodiments also move the head 100 such that areas/layers of deposition volumes V of essentially any shape are created on the bed 200.

In addition to the movement in the first direction Dₓ and in the second direction D_{y}, the positioning arrangement 300 can be arranged to move the head 100 in a third direction Dₓ perpendicular to the first direction Dₓ and the second direction D_{y}, as shown in FIG. 1a. Thereby, the head 100 can further be moved up and down relative to the surface 210a, 210b, . . . , 210n, i.e. relative to the bed 200. The movement of the head 100 in the third direction D_{z} can e.g. be used to move the head 100 away from the surface 210a, 210b, . . . , 210n, when the head 100 is going to be moved to a new position. The movement of the head 100 in the third direction D_{z} may further be used to build layers L₁, L₂, . . . , Lₙ of deposition volumes V on top of each other. For example, after a layer Lₙ of deposition volumes V has been deposited on the surface 210a, 210b, . . . , 210n of the bed 200, the positioning arrangement 300 can move the head 100 in the third direction D_{z}, away from the bed 200, to start a new layer Lₙ₊₁ on top of the previous layer Lₙ. The same effect may further be achieved by moving the bed 200 away from the head 100, i.e. lowering the bed 200.

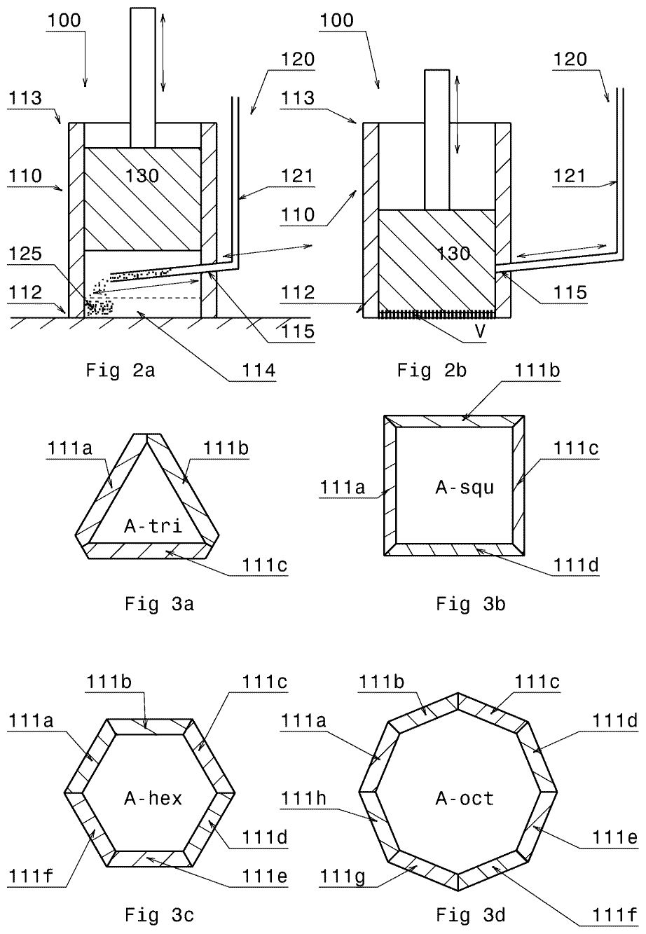

FIGS. 2a-b shows a head 100 of a deposition arrangement 600 according to embodiments of the invention. As shown in FIGS. 2a-b, the head 100 includes a casing/container/holder 110, at least one material receiving arrangement 115, and a piston 130. The at least one material receiving arrangement 115 may e.g. includes one or more wall openings, through which the granular material may be provided into the casing 110 by a material providing arrangement 120. The casing 110 includes at least three wall segments 111a, 111b, . . . , 111n (shown in FIGS. 3a-d) defining a deposition area A. The wall segments 111a, 111b, . . . , 111n extend from a first end 112 to a second end 113 of the casing 110. The first end 112 of the casing 110 includes an end opening 114 arranged to be positioned on a surface 210a, 210b, . . . , 210n. In the embodiment shown in FIGS. 2a-b, the casing 110, and thereby the end opening 114, is positioned directly on the surface 210a of the bed 200 of the deposition arrangement 600.

The material providing arrangement 120 is arranged to provide a granular material 125 into the casing 110 and onto the surface 210a via the material receiving arrangement 115 of the head 100. The amount of material provided by the material providing arrangement 120 into the casing 110 may be a predetermined amount, e.g. determined and controlled by a control unit, such as the control unit 500. In the embodiment shown in FIGS. 2a-b, the material providing arrangement 120 includes a tube 121 arranged to be attached to a container 122 (shown in FIG. 1a) including the granular material 125. The tube 121 is arranged to provide the granular material 125 from the container 122 into the casing 110 and onto the surface 210a through the material receiving arrangement 115 including e.g. a wall opening in at least one of the wall segments 111a, 111b, . . . , 111n. Furthermore, the tube 121 may be arranged to be movable relative to the material receiving arrangement 115, e.g. relative to the wall opening of the at least one wall segment 111a, 111b, . . . , 111n, and hence relative to the casing 110, as shown in FIGS. 2a-b, The movement of the tube 121 relative to the wall opening 115 causes the granular material 125 to be spread over the deposition area A. In various embodiments, more than one tube 121, one container, and/or one wall opening 115 may be used in the material providing arrangement 120 to convey one or more granular materials 125 into the casing 110. For example, a first tube, a first container, and a first wall opening may be used to convey a first granular material into the casing 110, while a second tube, a second container, and a second wall opening may be used to convey a second granular material into the casing 110. Furthermore, other means than a tube may be used in the material providing arrangement 120 to convey the granular material 125 such as e.g. a pipe or a chute.

The piston 130 is arranged to be movable inside of the casing 110, towards the first end 112 and towards the second end 113, as indicated with arrows in FIGS. 2a-b. When the piston 130 is moved towards the first end 112, the piston 130 presses the granular material 125 provided into the casing 110 by the material providing arrangement 120 against the surface 210a. The granular material 125 is thereby compressed and forms a deposition volume V. The pressure of the piston 130 is selected such that the formed deposition volume V has a certain stability and can maintain its shape when the piston 130 is moved away from the formed deposition volume V.

According to various embodiments of the invention, the piston 130 and/or the material providing arrangement 120 may further be arranged to cause a vibration to spread the provided granular material 125 over the deposition area A. The vibration caused by the piston 130 causes the granular material 125 in the casing 110 to be spread more evenly over the deposition area A as the granular material 125 is being pressed against the surface 210a by the piston 130. The vibration caused by the material providing arrangement 120 causes the granular material 125 in the casing 110 to be spread more evenly over the deposition area A during the providing of the granular material 125. In embodiments, the vibrations caused by the material providing arrangement 120 may fluidize the granular material 125 in the tube 121 to further improve the spreading of the granular material 125. With a more even spread of the provided granular material 125 over the deposition area A, a deposition volume V with a more even density can be formed. The piston 130 and/or the material providing arrangement 120 may be arranged to cause a vibration using known techniques such as e.g. one or more piezo-electric techniques/elements.

The size and shape of the deposition volume V of the granular material 125 deposited by the head 100 are determined by the size and shape of the deposition area A of the casing 110, in combination with the amount of granular material 125 provided into the casing 110 and the pressure provided by the piston 130. One or more of these factors may be adapted depending on e.g. the type of object to be fabricated and the material used.

The shape of the deposition area A of the casing 110 is determined by the number of wall segments 111a, 111b, . . . , 111n included in the casing 110, while the size of the deposition area A of the casing 110 is determined by the lengths of end sides of the included wall segments 111a, 111b, . . . , 111n facing the surface 210a, 210b, . . . , 210n. FIGS. 3a-d show deposition areas A of the casing 110 according to various embodiments of the invention. In FIG. 3a, the casing 110 has three wall segments 111a, 111b, 111c forming a triangular deposition area Aₜᵣᵢ. FIG. 3b shows an embodiment where the casing 110 has four wall segments 111a, 111b, 111c, 111d. In the embodiment shown in FIG. 3b, all four end sides of the wall segments 111a, 111b, 111c, 111d have the same length and hence form a square deposition area A_{squ}. However, in embodiments the lengths of the end sides of the four wall segments 111a, 111b, 111c, 111d may instead be selected such that they form a rectangular deposition area A_{rec} (not shown in Figs.). In FIG. 3c, the casing 110 has six wall segments 111a, 111b, 111c, 111d, 111e, 111f forming a hexagonal deposition area A_{box}. FIG. 3d shows an embodiment where the casing 110 has eight wall segments 111a, 111b, 111c, 111d, 111e, 111f, 111g, 111h forming an octagonal deposition area A_{oct}. Hence, by changing the number of wall segments 111a, 111b, . . . , 111n and the lengths of their end sides, the size and shape of the deposition area A, and thereby the size and shape of the deposition volume V, can be changed.

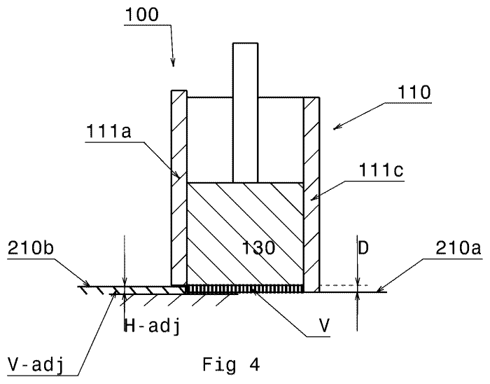

To be able to deposit deposition volumes V of the granular material 125 close to each other, the wall segments 111a, 111b, . . . , 111n of the casing 110 may be individually retractable from the surface 210a, 210b, . . . , 210n. Hence, according to embodiments of the invention at least one 111a of the at least three wall segments 111a, 111b, . . . , 111n is individually retractable from the surface 210a, 210b, . . . , 210n. FIG. 4 shows a head 100 including a retractable wall segment 111a according to an embodiment of the invention, The casing 110 of the head 110 shown in FIG. 4 includes four wall segments 111a, 111b, 111c, 111d of which only two wall segments 111a, 111c are visible as FIG. 4 shows a cross section of the head 100. In the embodiment shown in FIG. 4, the retractable wall segment 111a is arranged to be retracted a distance D essentially corresponding to a height H_{adj} of at least one adjacent deposition volume V_{adj} formed on the surface 210a. In this way, when the retractable wall segment 111a is retracted the distance D, the casing 110 can be positioned such that the retractable wall segment 111a is positioned on the surface 210b of the adjacent deposition volume V_{adj}, while the wall segment 111c is positioned on the surface 210a. Hence, the end opening 114 of the casing 110 covers a portion of the surface 210a directly adjacent to the adjacent deposition volume V_{adj}. When a deposition volume V is deposited by the head 100, the deposition volume V will be formed with one edge in contact with the adjacent deposition volume V_{adj}. In other words, no gap is created between the deposition volume V and the adjacent deposition volume V_{adj}. In various embodiments, each of the wall segments 111a, 111b, . . . , 111n included in the casing 110 may be individually retractable. Thereby, areas of deposition volumes V can be deposited where each deposition volume V is edge to edge with one or more, e.g. all, of its neighboring deposition volumes V.

The at least one retractable wall segment 111a may be arranged to be retracted by use of mechanically controlled retraction and/or temperature controlled retraction. Mechanically controlled retraction may e.g. be achieved by using a rod, an axis or similar, controlled by e.g. a motor, For example, a threaded rotatable rod may be used which lifts/lowers the wall Segment 111a when it is being rotated. The mechanically controlled retraction may also be achieved by arrangements utilizing spring-loads and/or toothed shafts arranged for retracting the wall segments. When temperature controlled retraction is used, the material of the retractable wall segment 111a is selected such that changes in temperature causes the material to expand and contract in a controlled way.

According to embodiments of the invention a method 800 for controlling a head 100 of a deposition arrangement 600 is provided. The method 800 includes
moving 802 the head 100 to a predetermined position on the surface 210a, 210b, . . . , 210n;
positioning 804 the end opening 114 of the casing 110 on the surface 210a, 210b, . . . , 210n;
providing 806 a predetermined amount of the granular material 125 into the casing 110;
pressing 808 the piston 130 towards the surface 210a, 210b, . . . , 210n, such that the granular material 125 is pressed against the surface 210a, 210b, . . . 210n and forms a deposition volume V;
retracting 810 the casing 110 from the surface 210a, 210b, . . . , 210n; and
retracting 812 the piston 130 from the surface 210a, 210b, . . . , 210n.

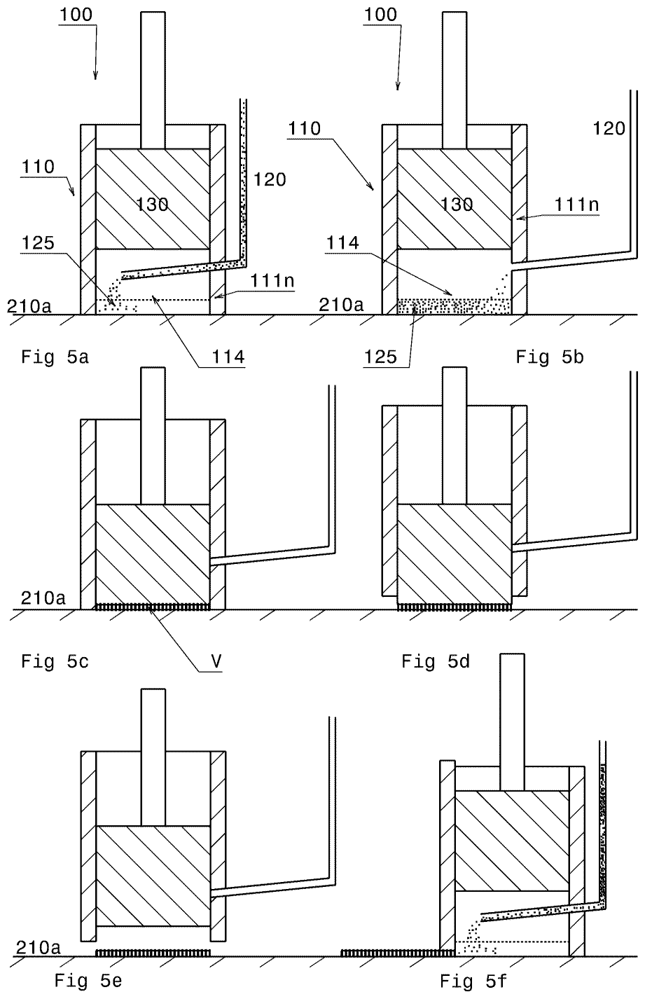

FIGS. 5a-f show different stages of the method 800 according to an embodiment of the invention. Note, although not set out in FIGS. 5c-f, the references given in FIGS. 5a-b also applies in FIGS. 5c-f. In FIG. 5a, the head 100 has been moved 802 to a predetermined position on a surface 210a and the end opening 114 of the casing 110 has been positioned 804 on the surface 210a. The providing 806 of a predetermined amount of the granular material 125 into the casing 110 has started. The providing 806 of material may be performed by the material providing arrangement 120 and the material receiving arrangement 115 as previously described. The material providing arrangement 120 may move relative to the casing 110 such that the granular material 125 is spread over the deposition area A, as shown in FIGS. 5a-b. In FIG. 5b, the providing 806 of the predetermined amount of the granular material 125 into the casing 110 is almost finished and the material providing arrangement 120 had been moved into the wall segment 11 in of the casing 110. FIG. 5c shows the pressing 808 of the piston 130 towards the surface 210a causing the granular material 125 to be pressed against the surface 210a to form a deposition volume V. The pressing 808 is performed using a pressure P selected to give the formed deposition volume V a certain stability. The pressure P may e.g. be selected such that the formed deposition volume V corresponds to as so-called green body, i.e. an intermediate stage where the granular material 125 is pressed into a desired shape which can be maintained after the pressure P is removed. The pressure P may e.g. be determined based on factors such as e.g. the size of the grains of the granular material 125, the size and shape of the deposition area A, the size and shape of the deposition volume V, and whether the deposition volume V will be moved before conversion into a solid material or not. The pressure P may further be determined based on the stability of the surface 210a, 210b, . . . , 210n, and hence the stability of the layer L₁, L₂, . . . , Lₙ, respectively, upon which the deposition volume V is formed. In embodiments, the pressure P used for the pressing 808 of the piston 130 towards the surface 210a, 210b, . . . , 210n may therefore be regulated based on the stability of the surface 210a, 210b, . . . , 210n. The pressure P may in embodiments be determined and controlled by a control unit, such as e.g. the control unit 500 described with reference to FIGS. 1a-b.

When the deposition volume V has been formed by the pressing 808, the head 100 is moved away from surface 210a. Firstly, the casing 110 is retracted 810 from the surface 210a, as shown in FIG. 5d. When the casing 110 has been retracted 810, the piston 130 is retracted 812 from the surface 210a, as shown in FIG. 5e. By retracting the casing 110 before retracting the piston 130, the risk that the deposition volume V sticks to the piston 130 and is retracted from the surface 210a with the piston 130 is reduced. To further reduce the risk that the deposition volume V sticks to the piston 130, the surface of the piston 130 facing the deposition volume V may be made of a non-stick material or other suitable material.

In FIG. 5f, the head 100 has been moved to a position on the surface 210a adjacent to the previously deposited deposition volume V where the method 800 is repeated to form a new deposition volume V. To be able to deposit the new deposition volume V next to, i.e. in contact with, the previously deposited deposition volume V, the wall segment 111a has been retracted such that the wall segment 111a can be positioned on top of the previously deposited deposition volume V.

The granular material 125 provided into the casing 110 during the providing 806 step of the method 800 may be the same every time the method 800 is performed or may differ. For example, in the embodiment shown in FIGS. 5a-f, a first granular material 125a may be provided 806 into the casing 110 in FIGS. 5a-b, while a second granular material 125b may be provided 806 into the casing 110 in FIG. 5f. Thus, the method 800 may in embodiments include performing the method 800 a first time, where a first granular material 125a is provided into the casing 110 during the providing 806; and performing the method 800 a second time, where a second granular material 125b different from the first granular material 125a is provided into the casing 110 during the providing 806.

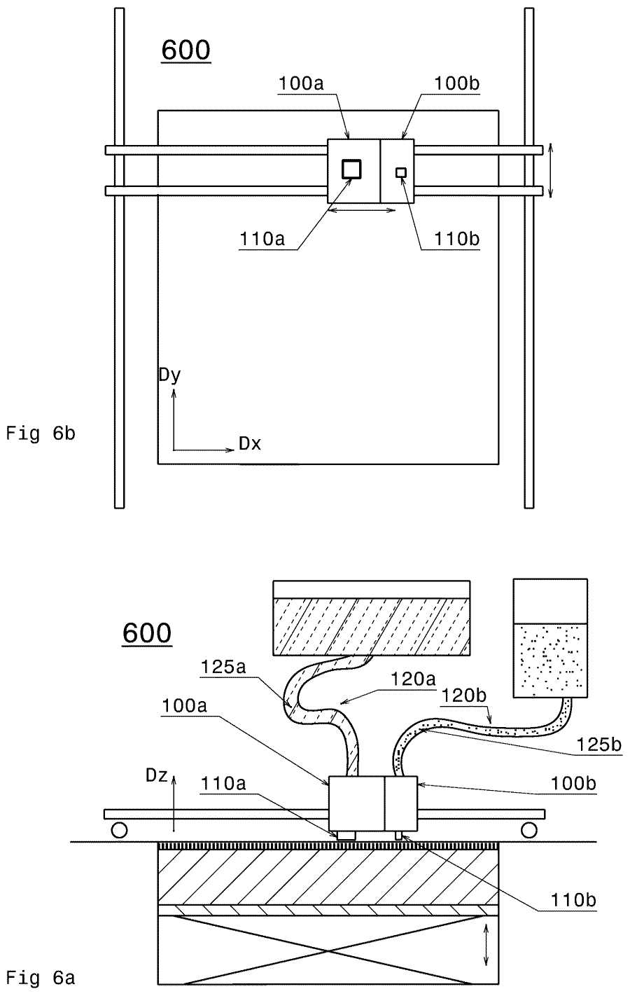

According to embodiments of the invention, two or more different granular materials 125 may further be handled by two or more heads 100. FIGS. 6a-b shows a deposition arrangement 600 including a first head 100a and a second head 100b according to such an embodiment. In the embodiment shown in FIGS. 6a-b, the first head 100a includes a first casing 110a and is arranged to receive a first granular material 125a from a first material providing arrangement 120a, while the second head 100b includes a second casing 110b and is arranged to receive a second granular material 125b from a second material providing arrangement 120b. Thus, when the method 800 is performed by the deposition arrangement 600 shown in FIGS. 6a-b, the method 800 may include performing the method 800 using the first head 100a, where the providing 806 of material includes providing 806 a predetermined amount of a first granular material 125a into the casing 110a of the first head 100a; and performing the method 800 using the second head 100b, where the providing 806 of material includes providing 806 a predetermined amount of a second granular material 125b different from the first granular material 125a into the casing 110b of the second head 100b.

In the embodiment shown in FIGS. 6a-b, the first casing 110a of the first head 100a has a larger deposition area A than the second casing 110b of the second head 100b. Therefore, the first granular material 125a is deposited in a first deposition volume Va, while the second granular material 125b is deposited in a second deposition volume Vb, being smaller than the first deposition volume Va. To be able to deposit different granular materials in deposition volumes of different size may e.g. be useful if one granular material is to be deposited over a larger area and/or requires less accuracy than the deposition of another granular material.

Furthermore, a method 800 for controlling the head 100 of the deposition arrangement 600 is provided which allows a partial deposition volume Vₚ to be deposited, where the partial deposition volume Vₚ is a sub-volume of the deposition volume V. This method 800 may e.g. be used when the surface 210a, 210b, . . . , 210n includes a gap between at least two adjacent deposition volumes V_{adj} having a surface area A_{gap}. The surface area A_{gap} being smaller than the deposition area A; A_{gap}<A. In this case, the positioning 804 may include positioning 804 said casing 110 such that the end opening 114 of the casing 110 covers the gap. After the providing 806 of the granular material 125 into the casing 110 and before the pressing 808 of the piston 130 towards the surface 210a, 210b, . . . , 210n, the casing 110 is moved parallel with the surface 210a, 210b, . . . , 210n such that said granular material 125 is moved into the gap. In other words, the casing 110 may be moved back and forth across the surface 210a, 210b, . . . , 210n to push/shovel the granular material 125 inside the casing 110 on top of the at least two adjacent deposition volumes V_{adj} into the gap. Thus, when the pressing 808 of the piston 130 towards the surface 210a, 210b, . . . , 210n is performed a partial deposition volume Vₚ is formed in the gap between the at least two adjacent deposition volumes V_{adj}.

By using one or more heads 100, according to the embodiments of the invention, to deposit two or more granular materials 125, objects can be fabricated out of the two or more granular materials 125 without the granular materials 125 having to be weldable/bondable to each other. For example, the two or more materials 125 may be fixed to each other by a mechanical coupling, although the two or more materials are actually unbondable to/with each other. For example, using the deposition arrangement 600 according to the embodiment shown in FIG. 6a-b, the first granular material 125a and the second granular material 125b can be deposited by the first head 100a and the second head 100b, respectively, in specific well-defined positions and individually solidified. Thereby, essentially any pattern of the solidified first material 125a and the solidified second material 125b can be formed. This allows elements of the first solidified material 125a and the second solidified material 125b, respectively, to be formed which can be mechanically locked to each other during the fabrication process. This is possible, since the geometrical shapes of the first 125a and second 125b solidified materials may be very exactly formed such that the forces possibly acting on either or both of the first 125a and second 125b solidified materials may be counteracted by the mechanical coupling of the first 125a and second 125b solidified materials. For example, different types of joints/couplings/fixations/lockings can be formed that are able to fix/lock a first element fabricated from the first granular material 125a to a second element fabricated from the second granular material 125b.

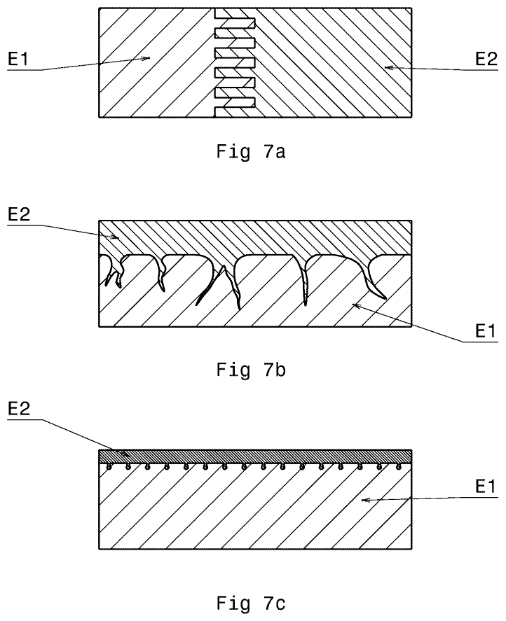

FIGS. 7a-c show objects including a mechanical coupling between a first element E1 fabricated/solidified from the first granular material 125a and second element E2 fabricated/solidified from the second granular material 125b according to embodiments of the invention. FIG. 7a shows an object where the first element E1 and second element E2 are locked to each other using a finger joint/coupling. Each finger in the finger joint/coupling may e.g. be one or more layers Lₙ high. In FIG. 7b, an organic joint/coupling has been formed between the first element E1 and the second element E2 of the object. The organic joint/coupling may be designed, e.g. using mathematical optimization, to achieve a strong joint/coupling considering the characteristics of the different materials and/or considering the forces acting on the first element E1 and the second element E2. FIG. 7c shows an object where the first element E1 constitutes a main part and second element E2 is joint/coupled/fixed to the first element E1 such that the second element E2 creates a surface layer. The object can hence be coated with the second element E2 fabricated/solidified from the second granular material 125b and thereby be given certain surface properties.

Also, using one or more heads 100, according to the embodiments of the invention, to deposit two or more granular materials 125, objects can be fabricated out of the two or more granular materials 125 such that at least one or the two or more materials is used as a dopant, i.e. as a dopant agent. Thus, at least one material may be coupled to, e.g. as being included within, another material to alter the one or more properties of the other material by doping. This is easily achieved by the embodiments of the present invention, since very exact geometrical shapes/forms/coupling between the two or more solidified materials may be provided, also for materials not being able to weld/bond to each other.

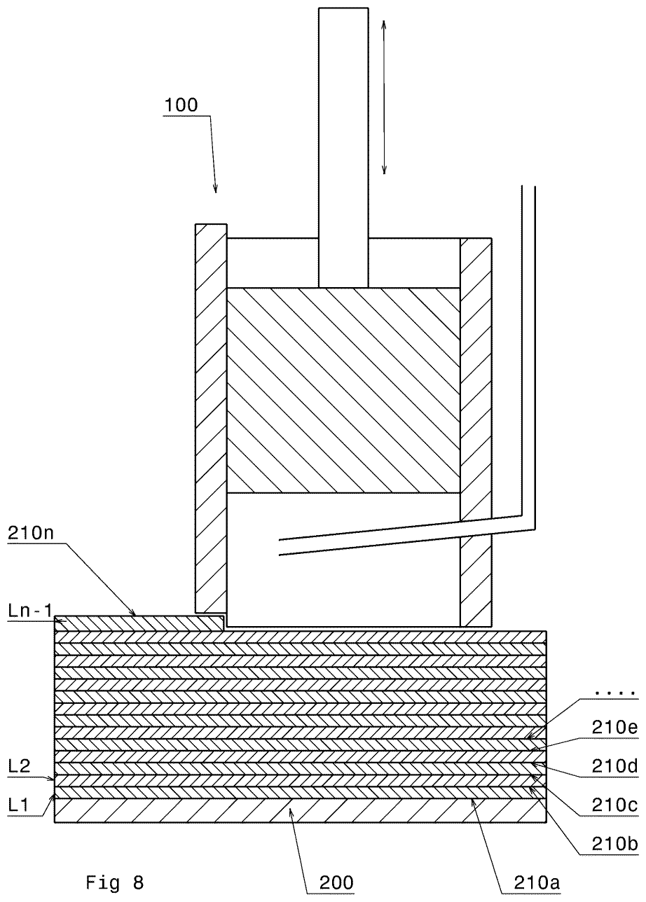

FIG. 8 shows the forming of layers L₁, L₂, . . . , Lₙ according to an embodiment of the invention. In the embodiment shown in FIG. 8, the head 100 forms continuous layers L₁, Lₙ, . . . , Lₙ by moving across the surface 210a, 210b, . . . , 210n, respectively, depositing deposition volumes V edge to edge with each other. On the surface 210a of the bed 200 a first layer L₁ has been formed by the head 100. The surface 210b of the first layer L₁ is the surface upon which the head 100 forms the second layer L₂ and so on. In this way, objects may be created layer-by-layer. Although the layers L₁, L₂, . . . , Lₙ in FIG. 8 have the same height, the head 100 may in various embodiments instead be arranged to form layers L₁, L₂, . . . , Lₙ of varying heights and/or one or more layers L₁, L₂, . . . , Lₙ having a height which varies across its/their surface. Furthermore, each layer Lₙ may comprise deposition volumes V of one or more materials such that the layers L₁, L₂, . . . , Lₙ may together form one or more elements of the one or more materials, respectively.

It is to be noted that although some embodiments of the invention are herein described for a deposition arrangement 600 with one or two heads 100 having a square shape, a deposition arrangement 600 according to embodiments of the invention can include any number of heads 100a, 100b, . . . , 100n having any shape without deviating from the scope of the invention.

1-24. (canceled)

25. A method for controlling at least one head of a deposition arrangement,
the head comprising:
a casing comprising at least three wall segments defining a deposition area and extending from a first end to a second end of said casing, said first end of said casing comprising an end opening arranged to be positioned on a surface; and
at least one material receiving arrangement arranged to receive a granular material into said casing and onto said surface; and
a piston arranged to be movable inside of the casing, towards said first end and towards said second end, such that said piston presses said granular material against said surface when said piston is moved towards said first end, said granular material thereby forming a deposition volume,
the method comprising:
moving said head to a predetermined position on said surface;
positioning said end opening of said casing on said surface;
providing a predetermined amount of said granular material into said casing;
pressing said piston towards said surface, such that said granular material is pressed against said surface and forms a compressed deposition volume;
retracting said casing from said surface; and
retracting said piston from said surface,
the method further comprising:
performing the method a first time at a first predetermined position, to form a first deposition volume, and
performing the method a second time at a second predetermined position, adjacent said first predetermined position, to form a second deposition volume in contact with the first deposition volume, such that said first and second deposition volumes form a continuous layer.

26. The method according to claim 25, the method further comprising:
performing the method a first time, wherein a first granular material is provided into said casing during said providing; and
performing the method a second time, wherein a second granular material different from the first granular material is provided into said casing during said providing.

27. The method according to claim 25, the method further comprising:
performing the method using a first head, wherein said providing includes providing a predetermined amount of a first granular material into a casing of said first head; and
performing the method using a second head, wherein said providing includes providing a predetermined amount of a second granular material different from the first granular material into a casing of said second head.

28. The method according to claim 25, wherein at least one of said at least three wall segments is individually retractable from said surface and positionable on a surface of one or more previously deposited volumes.

29. The method according to claim 25, wherein said at least one retractable wall segment is retractable, by mechanically controlled or temperature controlled retraction, from said surface by a distance essentially corresponding to a height of at least one adjacent deposition volume formed on said surface.

30. The method according to claim 28, wherein said material receiving arrangement includes at least one wall opening in at least one of said wall segments.

31. The method according to claim 25, wherein said casing has one in the group of:
three wall segments forming a triangular deposition area;
four wall segments forming a rectangular deposition area;
four wall segments forming a square deposition area;
six wall segments forming a hexagonal deposition area; and
eight wall segments forming an octagonal deposition area.

32. The method according to claim 25, wherein said providing a predetermined amount of said granular material comprises vibrating the granular material to spread the granular material over the deposition area.

33. The method according to claim 25, wherein said pressing is performed with a piston pressure sufficient for the deposition volume to maintain its shape when the piston is moved away from the formed deposition volume.

34. method according to claim 25, wherein the first and second predetermined positions are in a same plane, perpendicular to a direction of movement of the piston, such that the first and second deposition volumes are coplanar in said plane.

35. The method according to claim 25, further comprising converting said first and second deposition volumes into a continuous solid material.

36. The method according to claim 35, wherein said converting comprises sintering or melting the compressed granular material of the deposition volumes.

37. The method according to claim 25, wherein
the method is repeated a first plurality of times to form a first layer of said deposition volumes on the surface, and
wherein the method is repeated a second plurality of times to form a second layer of said deposition volumes, on top of the first layer of deposition volumes.

38. The method according to claim 35, wherein said converting comprises conversion of the granular material into a solid material simultaneously for two or more layers of deposition volumes.

39. A deposition arrangement, comprising:
at least one head comprising:
a casing comprising at least three wall segments defining a deposition area and extending from a first end to a second end of said casing, said first end of said casing comprising an end opening arranged to be positioned on a surface; and
at least one material receiving arrangement arranged to receive a granular material into said casing and onto said surface; and
a piston arranged to be movable inside of the casing, towards said first end and towards said second end, such that said piston presses said granular material against said surface when said piston is moved towards said first end, said granular material thereby forming a deposition volume,
at least one material providing arrangement arranged to provide granular material to said at least one material receiving arrangement;
at least one bed comprising a surface;
at least one positioning arrangement arranged to position said head on said surface of said bed or on a surface of a previously deposited layer of deposition volumes;
at least one material conversion arrangement arranged to convert said granular material of said deposition volume into a solid material; and
at least one control unit arranged to control one or more of said at least one head, said at least one material providing arrangement, said at least one bed, said at least one positioning arrangement, and said at least one material conversion arrangement.

40. The deposition arrangement according to claim 39, wherein said positioning arrangement is configured to position the head such that a second deposition volume is provided laterally adjacent, and in contact with, a first deposition volume.

41. The deposition arrangement according to claim 39,
wherein said at least one positioning arrangement is arranged to move said head in a first direction, in a second direction perpendicular to the first direction, and in a third direction perpendicular to the first direction and the second direction.

42. The deposition arrangement according to claim 39,
wherein each one of said at least one material conversion arrangement is arranged to perform one in the group of:
converting said granular material into a solid material individually for each layer of deposition volumes; and
converting said granular material into a solid material simultaneously for two or more layers of deposition volumes.

43. The deposition arrangement according to claim 39,
wherein said at least one material providing arrangement includes:
at least one container comprising said granular material; and
at least one tube arranged to be attached to said at least one container, respectively, said at least one tube being arranged to provide said granular material from said at least one container to said at least one material receiving arrangement.

44. The deposition arrangement according to claim 43, wherein said at least one tube is arranged to be movable relative to said at least one material receiving arrangement, respectively, such that said granular material is spread over said deposition area.

45. A computer program stored on a non-transitory computer readable medium comprising instructions which, when the program is executed by a computer, cause the computer to carry out the method according to claim 25.
